(19) United States
(12) Patent Application Publication
(10) Pub. No.: US 2024/0383052 A1
(43) Pub. Date: Nov. 21, 2024

(54) MACHINE TOOL FOR PRODUCING A WORKPIECE OF PREDEFINED LENGTH

(71) Applicant: Phoenix Contact GmbH & Co. KG, Blomberg (DE)

(72) Inventors: Tim ALSTERS, Paderborn (DE); Alexander GENSE, Bad Pyrmont (DE); Timo TARRACH, Bielefeld (DE); Christoph MARTEN, Vlotho (DE); Waldemar SOMMER, Detmold (DE); Henning REY, Steinheim (DE)

(21) Appl. No.: 18/558,197

(22) PCT Filed: May 4, 2022
(86) PCT No.: PCT/EP2022/061973

§ 371 Date: Oct. 31, 2023

(30) Foreign Application Priority Data
May 11, 2021 (BE) BE2021/5379

(51) Int. Cl. B23D 47/04; B23D 59/00

(52) U.S. Cl. CPC B23D 47/04; B23D 59/001

(57) ABSTRACT

A machine tool for producing a workpiece of predefined length includes: a frame for receiving the workpiece, which extends in a longitudinal direction and guides the workpiece in the longitudinal direction at least in part; a cutting tool for severing the workpiece in a machining position; a drivable stop element which is mounted on the frame so as to be displaceable in order to move the workpiece into the machining position; and at least one actuable slide element which is mounted on the frame so as to be displaceable guides the workpiece when the at least one actuable slide element is moved by the drivable stop element.

### CROSS-REFERENCE TO PRIOR APPLICATIONS

This application is a U.S. National Phase application under 35 U.S.C. § 371 of International Application No. PCT/EP2022/061973, filed on May 4, 2022, and claims benefit to Belgian Patent Application No. BE 2021/5379, filed on May 11, 2021. The International Application was published in German on Nov. 17, 2022 as WO/2022/238198 under PCT Article 21(2).

### FIELD

The present invention relates to a machine tool for producing, preferably for cutting to length, a workpiece of predefined length, having a frame for receiving the workpiece, which extends in a longitudinal direction and is configured to guide the workpiece in the longitudinal direction at least in part.

### BACKGROUND

Machine tools for cutting workpieces such as support rails are known in the prior art in a plurality of different configurations. The workpiece to be produced or machined must often be inserted into the tool in a complicated manner by hand. This applies primarily to machine tools which are provided for cutting or severing elongated rod profiles.

For example, a cross-cutting system for cutting workpieces to a desired length and a machining device having a longitudinal stop and a cutting tool is known from the German application No. DE 10 2015 211 692 A1. The longitudinal stop is mounted so as to be displaceable in the machining direction in order to adjust to the determined length of the workpiece. A distance measuring device is used to determine the desired length. The distance measuring device in each case has a wireless or wired communication connection to the processing device via a communication module. In order to displace the longitudinal stop, an actuator is provided which adjusts the desired length as a function of the distance detected by the distance measuring device. Side stops, against which the workpiece to be machined can be placed, are fixedly arranged on the workpiece support.

In the European patent specification No. EP 1 837 110 B1, a stop rail for a panel saw is described which can be pivoted relative to the sectional plane by means of a pivot bearing. A first longitudinal stop surface and a second longitudinal stop surface are each guided via an actuator in the form of a threaded spindle in an independently movable and lockable manner along the longitudinal direction of the stop rail in order to position the workpiece according to two dimensions to be cut.

### SUMMARY

In an embodiment, the present invention provides a machine tool for producing a workpiece of predefined length, comprising: a frame configured to receive the workpiece, which extends in a longitudinal direction and is configured to guide the workpiece in the longitudinal direction at least in part; a cutting tool configured to sever the workpiece in a machining position; a drivable stop element which is mounted on the frame so as to be displaceable in order to move the workpiece into the machining position; and at least one actuable slide element which is mounted on the frame so as to be displaceable and is configured to guide the workpiece when the at least one actuable slide element is moved by the drivable stop element.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a perspective view of a first exemplary embodiment of the machine tool according to the present invention;

FIG. 2 shows a front view of the machine tool depicted in FIG. 1;

FIG. 3 shows a plan view of the machine tool depicted in FIG. 1; and

FIG. 4 shows a side view (side view from the left) of the machine tool depicted in FIG. 1.

### DETAILED DESCRIPTION

In an embodiment, the present invention provides a machine tool for producing, preferably for cutting to length, a workpiece of predefined length, which machine tool is improved with regard to handling and operation. The machine tool may be characterized by optimized production of elongated workpieces, such as support rails.

According to a general aspect, the invention relates to a machine tool for producing, preferably for cutting to length, a workpiece, preferably a support rail, of a predefined length, having a frame for receiving the workpiece, which extends in a longitudinal direction and is configured to guide the workpiece, i.e., the received workpiece, in the longitudinal direction at least in part, wherein the machine tool comprises a cutting tool in order to sever the received workpiece in a machining position, wherein the machine tool has a drivable stop element which is mounted on the frame so as to be displaceable, preferably in the longitudinal direction, in order to move the received workpiece into the machining position, and wherein the machine tool has at least one actuable slide element which is mounted on the frame so as to be displaceable, preferably substantially in the longitudinal direction, and is configured to guide the received workpiece when it is moved by the drivable stop element.

The machine tool according to the present invention is characterized, for example, in that instead of rigidly fixed stops, i.e., non-movable stops, strips or ramps, at least one movable guide element is used in order to guide a received workpiece, which movable guide element, together with the received workpiece, moves at least in part in one direction and guides said workpiece.

In this way, trouble-free and positionally accurate feeding of the workpiece to the cutting tool can be ensured, in particular in the case of comparatively long and/or rod-shaped workpieces, such as, for example, support rails having an initial length of, for example, 2000 mm. The machine tool can therefore preferably be configured to produce rod-shaped and/or bar-shaped workpieces in the form of a severing of these workpieces in order to produce a workpiece of predefined length. With the machine tool according to the present invention, it is possible to automatically cut the workpiece to the predefined length.

The cutting tool can preferably be configured such that the workpiece can be passed through the cutting tool in the longitudinal direction. In other words, the cutting tool can have a through-opening or a through-channel in which the severing of the received workpiece takes place. The cutting tool can have a clamping mechanism in order to releasably fasten the workpiece at least in part during the severing process. The drivable stop element can be driven, for example, hydraulically or by means of an electric motor. The drivable stop element can have a holding portion in order to be able to detachably fasten a free end of the workpiece to the holding portion, for example by means of clamping connections or by means of plug-in connections.

According to a further aspect of the invention, it can be provided that the at least one actuable slide element is configured to be actuated by the received workpiece via at least one contact portion of the at least one actuable slide element. Thus, the workpiece can itself cause the at least one actuable slide element to move and, for example, no additional drive is necessary. For this purpose, the at least one actuable slide element can accordingly be mounted on the frame so as to be displaceable. The at least one contact portion can be, for example, a pin-shaped or plate-shaped flat or plate-shaped curved contact portion, which the received workpiece contacts at least in part.

It is possible for at least one contact portion, preferably at least one further contact portion, of the at least one actuable slide element to form a stop for the received workpiece, preferably transversely to the longitudinal direction. A defined and/or precise position of the workpiece received relative to the frame and/or to the cutting tool can thereby be ensured, preferably before the workpiece is severed by the cutting tool.

According to a further aspect of the invention, it can be provided that the at least one actuable slide element is mounted so as to be displaceable in the longitudinal direction between the drivable stop element and the cutting tool. Uniform mounting and guidance of the workpiece to be received can thus be ensured, in especially in the case of comparatively long and thin workpieces.

It is possible for the machine tool to have at least one light barrier which is arranged on the cutting tool and is configured to determine at least one zero position on the received workpiece or to define it for machining by the cutting tool by means of at least one light signal which is transmitted to the received workpiece and is reflected by the received workpiece or is a non-reflected light signal.

According to a further aspect of the invention, it can be provided that the machine tool has a control and regulating unit which is connected at least to the cutting tool, to the drivable stop element and the light barrier via a signal connection, wherein the control and regulating unit is configured to activate the drivable stop element via the signal connection in order to move, preferably to displace, the received workpiece translationally into the machining position, preferably as a function of at least one light signal of a light barrier which is transmitted to the received workpiece and is reflected by the received workpiece or is a non-reflected light signal.

It is possible for the machine tool to have a display and operating unit which is connected at least to the control and regulating unit via a signal connection and is configured to query at least the predefined length of the workpiece. The display and operating unit can be designed, for example, as a touchscreen.

The signal connection can be a wired or a wireless signal connection.

It is possible for the machine tool to have at least one sensor unit in order to detect the presence of a received workpiece at least at a first point in time and at a second point in time. The at least one sensor unit can, for example, comprise an inductive sensor.

According to a further aspect of the invention, it can be provided that the at least one sensor unit is arranged on the at least one actuable slide element.

It is possible for the frame to be configured at least in part as a table which has a work plate for receiving the workpiece, wherein a groove or recess, which extends substantially in the longitudinal direction, is preferably formed on the work plate for the displaceable mounting of the at least one actuable slide element and/or for guiding the drivable stop element. It should be mentioned that the received workpiece itself preferably does not contact the table, i.e., the work plate of the table.

According to a further aspect of the invention, it can be provided that the frame has a receiving portion for the workpiece between the drivable stop element and the cutting tool, which receiving portion extends at least 2000 mm in the longitudinal direction. In this way, as already described above, comparatively long and thin workpieces in the form of support rails can be received on the machine tool and produced by the machine tool.

It is possible for the drivable stop element to be designed and/or configured to detachably fasten at least one portion of the received workpiece. For this purpose, the drivable stop element can comprise a plug-in portion and/or a clamping portion, preferably with a clamping device. The at least one portion of the received workpiece can preferably be a free end of the received workpiece. The received workpiece is thus supported, for example, only by the drivable stop element and the slide element.

Identical or functionally equivalent components or elements are denoted by the same reference signs in Figures. For the explanation thereof, reference is also made in part to the description of other exemplary embodiments and/or Figures in order to avoid repetitions.

The following detailed description of the exemplary embodiments illustrated in the figures serves for more detailed illustration or clarification and is not intended to limit the scope of the present invention in any way.

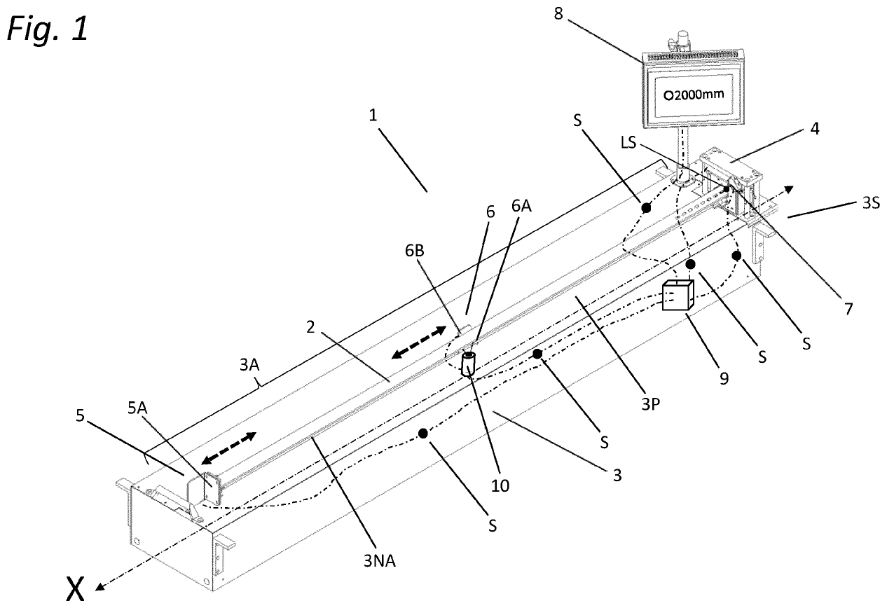

FIG. 1 is a perspective view of a schematically shown first embodiment of the machine tool 1 according to the present invention. The machine tool 1 is configured to produce a workpiece 2 and is described in more detail below. FIG. 1 shows the machine tool 1 with a received workpiece 2.

The workpiece 2 can preferably be a support rail of corresponding length. Particularly preferably, the workpiece 2 can be designed as a standard NS 35/15 support rail (known as a “DIN rail with hat-shaped profile”). The machine tool 1 can be configured to machine workpieces 2 in the form of support rails with an initial length of, for example, 2000 mm.

The machine tool 1 has a frame 3 for receiving the workpiece 2. The frame 3 extends substantially in a longitudinal direction X of the machine tool 1 and is configured to guide the received workpiece 2 in the longitudinal direction X at least in part. Furthermore, the frame 3 supports the workpiece 2 to be received via the further components and elements described below. The frame 3 is preferably configured as a table or has at least one substantially planar work plate 3P. This ensures, for example, that the workpiece 2 can be inserted into the machine tool 1 for machining at least two sides of the machine tool 1.

A groove 3NA or a recess 3NA for mounting and guiding corresponding further components and elements of the machine tool 1 extends substantially in the longitudinal direction X in the work plate 3P. The frame 3 can be produced, for example, from cast iron, steel or from a light metal and have a correspondingly sufficient strength and stiffness.

The machine tool 1 comprises a cutting tool 4 that is preferably configured as a cutter 4. The cutter 4 can be, for example, a laser beam cutter or a water jet cutter. Further or other embodiments and configurations of cutting tools are possible. It is thus possible, for example, for the cutting tool 4 to be designed as a saw.

The cutting tool 4 is arranged in the longitudinal direction X on an end face 3S of the frame 3. The cutting tool 4 is configured to be able to pass the received workpiece 2 through the cutting tool 4. In other words, the cutting tool 4 comprises a through-opening extending substantially in the longitudinal direction X for the passage of the received workpiece 2 through (not shown in detail in FIG. 1). In a machining position, the workpiece 2 can be severed, preferably cut through, by the cutting tool 4. Preferably, the workpiece 2 is severed in or within the cutting tool 4 and in a machining position, i.e., when the workpiece 2 is in a corresponding position.

The machine tool 1 comprises a drivable stop element 5. The drivable stop element 5 comprises two plate-shaped portions that are arranged substantially at a right angles to one another. It is possible for the drivable stop element 5 to be designed as a bent and/or punched part.

The drivable stop element 5 preferably has a holding portion 5A in order to be able to detachably fasten a free end of the workpiece 2 to the holding portion 5A, for example by means of clamping connections or by means of plug-in connections (not visible in FIG. 1). For this purpose, the holding portion 5A can have plug-in pins or wall portions (not visible in FIG. 1) protruding or projecting therefrom, which can at least in part form a positive connection with the workpiece 2.

The drivable stop element 5 is mounted in part in the groove 3NA or in the recess 3NA, which extends substantially in the longitudinal direction X. The drivable stop element 5 can be activated by a drive unit, for example an electric motor or a hydraulic pump (not visible in FIG. 1), in order to move substantially in the longitudinal direction X in the groove 3NA or in the recess 3NA. The drivable stop element 5 is provided to move a received workpiece 2 into the machining position. In other words, the drivable stop element 5 moves the received workpiece 2 in the direction of the cutting tool 4.

The machine tool 1 comprises an actuable slide element 6. According to a further or another embodiment of the present invention, it is possible for the machine tool 1 to have multiple actuable slide elements 6. The number of the actuable slide elements 6 can be selected, for example, as a function of the predefined length (initial length) of the workpieces 2 to be produced.

The actuable slide element 6 is mounted so as to be displaceable on the frame 3, i.e., on the work plate 3P in the groove 3NA or recess 3NA extending substantially in the longitudinal direction X, and is configured to guide the received workpiece 2 when it is moved by the drivable stop element 5, which is described in more detail below. The machine tool 1 is thus characterized, for example, in that no rigidly fixed, non-movable stops, strips or ramps are used to guide a received workpiece 2, but a guide element is present that, together with the received workpiece 2, moves at least part in one direction. The actuable slide element 6 is preferably mounted so as to be displaceable in the longitudinal direction X between the drivable stop element 5 and the cutting tool 4.

The actuable slide element 6 comprises a first contact portion 6A and a second contact portion 6B. The second contact portion 6B is mounted in the groove 3NA or in the recess 3NA so as to be displaceable and is in part plate-shaped. The second contact portion 6B forms, among other things, a stop transversely to the longitudinal direction X, i.e. a limit, for the received workpiece 2.

The actuable slide element 6 can, for example, be mounted so as to be displaceable by a sliding bearing. Alternatively, it is possible for the actuable slide element 6 to be mounted so as to be displaceable via a rolling bearing (not visible in the figures). The first contact portion 6A is configured to be actuated by the received workpiece 2. In other words, the received workpiece 2 can, even by contacting with the first contact portion 6A, cause the actuable slide element 6 to move. The first contact portion 6A can, for example, have at least one protruding bolt that at least in part contacts the received workpiece 2.

The machine tool 1 comprises a sensor unit 10. The sensor unit 10 is configured to detect the presence of a received workpiece 2 at least at a first point in time and at a second point in time. As a result, it can be ensured, for example, that the machine tool 1 only starts the production process, i.e., the separating process or cutting process of the workpiece 2, when there is a received workpiece 2. As shown in FIG. 1, the sensor unit 10 is preferably arranged on the actuable slide element 6. In alternative embodiments of the present invention, the sensor unit 10 can also be arranged, for example, at the entry region of the cutting tool 4.

The machine tool 1 comprises a light barrier 7. The light barrier 7 is preferably arranged on the cutting tool 4 and is configured to determine at least one zero position on the received workpiece 2 or to define it for machining by the cutting tool 4 by means of at least one light signal LS which is transmitted to the received workpiece 2 or is reflected by the received workpiece 2 or is a non-reflected light signal LS.

The machine tool 1 comprises a control and regulating unit 9. The control and regulating unit 9 preferably has electronic hardware components (for example CPU, RAM, ROM, bus system, etc.) and software components (real-time-capable operating system, application program for controlling and/or regulating the cutting tool 4 and the drivable stop element 5, etc.). The control and regulating unit 9 is connected via a signal connection S at least to the cutting tool 4, the drivable stop element 5, the light barrier 7, the sensor unit 10, the actuable slide element 6 and the display and operating unit 8. The signal connection S can be a wired or a wireless signal connection S. A correspondingly tuned activation of the relevant components and elements of the machine tool 1 can be carried out via the control and regulating unit 9.

The display and operating unit 8 can be designed, for example, as a touchscreen, via which parameters for the workpiece 2 to be produced, preferably for the predefined length of the workpiece 2, and settings for operating the machine tool 1 are queried and entered. The machine tool 1 is preferably configured and/or designed to process workpieces 2 having an initial length of, for example, 2000 mm. In other words, a receiving portion 3A of the frame 3 for the workpiece 2 to be received thus extends at least over a length of 2000 mm. The receiving portion 3A is located between the drivable stop element 5 and the cutting tool 4.

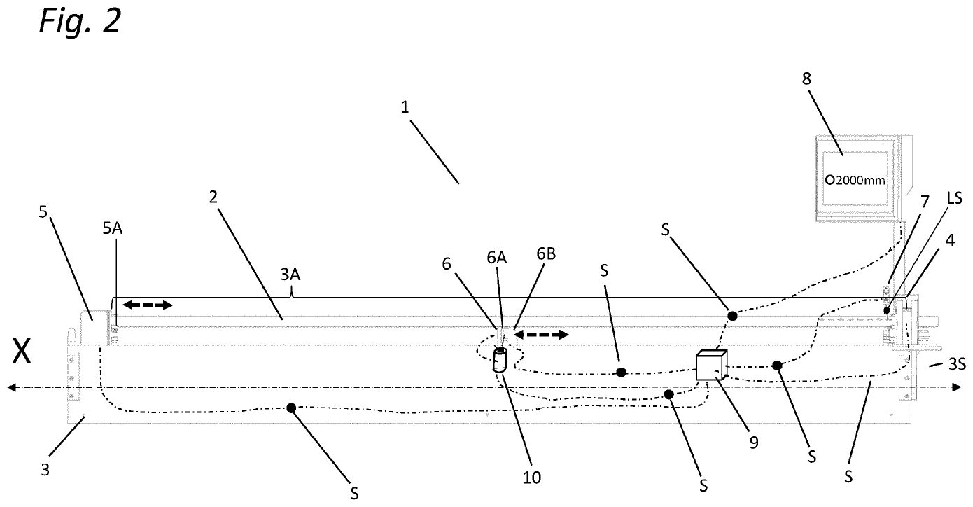

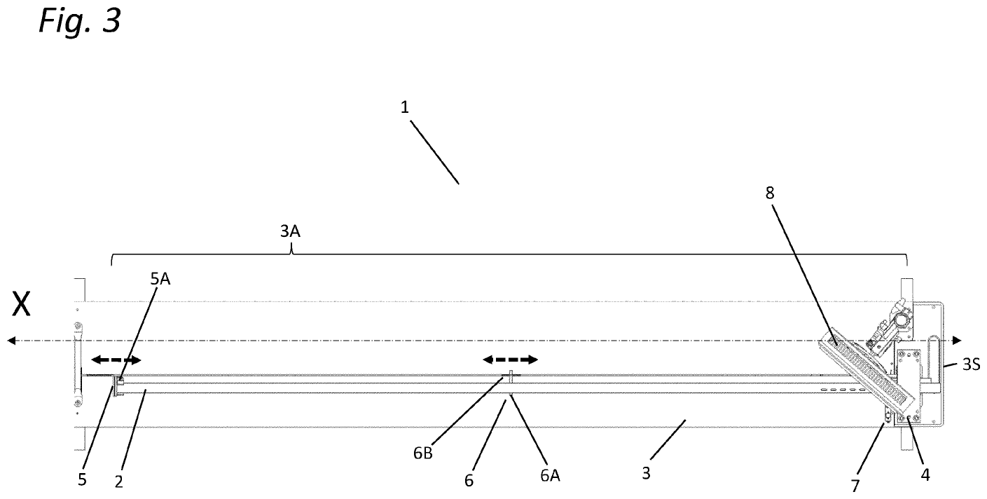

FIG. 2 is a front view of the machine tool 1 shown in FIG. 1 and FIG. 3 is a plan view of the machine tool 1 shown in FIG. 1. From the combination of FIG. 1 to 3, it can be seen that the frame 3 is substantially cuboid. Furthermore, it is apparent that the received workpiece 2 is passed through the cutting tool 4 and a portion of the workpiece 2 to be cut protrudes from the cutting tool 4 at the end face 3S of the frame 3. FIG. 2 and FIG. 3 at least partially show the holding portion 5A of the drivable stop element 5 on which the received workpiece 2 is, for example, clamped.

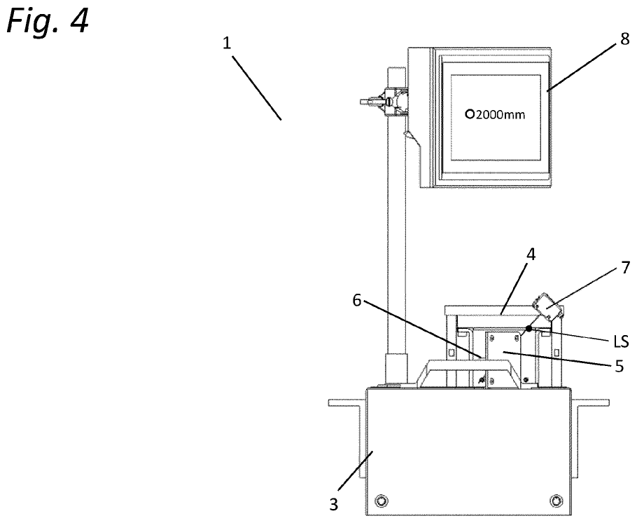

FIG. 4 is a side view (side view from the left) of the machine tool 1 shown in FIG. 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 machine tool
2 workpiece
3. frame
3A receiving portion
3P work plate of the frame
3NA groove or recess
3S end face
4 cutting tool
5 drivable stop element
5A holding portion
6 actuable slide element
6A first contact portion
6B second contact portion
7 light barrier
8 display and operating unit
9 control and regulating unit
10 sensor unit
LS light signal
S signal
X longitudinal direction

1: A machine tool for producing a workpiece of predefined length, comprising:
a frame configured to receive the workpiece, which extends in a longitudinal direction and is configured to guide the workpiece in the longitudinal direction at least in part;
a cutting tool configured to sever the workpiece in a machining position;
a drivable stop element which is mounted on the frame so as to be displaceable, in order to move the workpiece into the machining position;
and
at least one actuable slide element which is mounted on the frame so as to be displaceable and is configured to guide the workpiece when the at least one actuable slide element is moved by the drivable stop element.

2: The machine tool of claim 1,
wherein the at least one actuable slide element is configured to be actuated by the workpiece via at least one contact portion of the at least one actuable slide element.

3: The machine tool of claim 2,
wherein at least one contact portion of the at least one actuable slide element forms a stop for the workpiece.

4: The machine tool of claim 1,
wherein the at least one actuable slide element is mounted so as to be displaceable in the longitudinal direction between the drivable stop element and the cutting tool.

5: The machine tool of claim 1,
further comprising:
at least one light barrier which is arranged on the cutting tool and is configured to determine at least one zero position on the workpiece or to define the at least one zero position for machining by the cutting tool by at least one light signal which is transmitted to the workpiece and is reflected by the workpiece, or is a non-reflected light signal.

6: The machine tool of claim 5, further comprising:
a control and regulating unit which is connected at least to the cutting tool, to the drivable stop element, and the at least one light barrier via a signal connection,
wherein the control and regulating unit is configured to activate the drivable stop element via the signal connection in order to move the workpiece translationally into the machining position.

7: The machine tool of claim 6, further comprising:
a display and operating unit which is connected at least to the control and regulating unit via a signal connection and is configured to query at least the predefined length of the workpiece.

8: The machine tool claim 1, further comprising:
at least one sensor unit configured to detect a presence of the workpiece at least at a first point in time and at a second point in time.

9: The machine tool of claim 8,
wherein the at least one sensor unit is arranged on the at least one actuable slide element.

10: The machine tool of claim 1,
wherein the frame is comprises, at least in part, a table which has a work plate configured to receive the workpiece.

11: The machine tool of claim 1,
wherein the frame has a receiving portion for the workpiece between the drivable stop element and the cutting tool, which receiving portion extends at least 2000 mm in the longitudinal direction.

12: The machine tool of claim 1,
wherein the drivable stop element is designed-configured to releasably fasten at least one portion of the workpiece.

13: The machine tool of claim 1, wherein the drivable stop element is mounted on the frame so as to be displaceable in the longitudinal direction.

14: The machine tool of claim 1, wherein the at least one actuable slide element is mounted on the frame so as to be displaceable in the longitudinal direction.

15: The machine tool of claim 3, wherein at least one contact portion of the at least one actuable slide element forms the stop for the workpiece transversely to the longitudinal direction.

16: The machine tool of claim 6, wherein the control and regulating unit is configured to activate the drivable stop element via the signal connection in order to move the workpiece translationally into the machining position as a function of at least one light signal of a light barrier which is transmitted to the workpiece and is reflected by the workpiece or is a non-reflected light signal.

17: The machine tool of claim 10, wherein a groove or recess, which extends in the longitudinal direction, is formed on the work plate for the displaceable mounting of the at least one actuable slide element and/or for guiding the drivable stop element.
